(19) United States
(12) Patent Application Publication
(10) Pub. No.: US 2024/0302795 A1
(43) Pub. Date: Sep. 12, 2024

(54) DEVICE FOR AUTONOMOUSLY ADJUSTING THE ACTIVE LENGTH OF A BALANCE SPRING

(71) Applicant: The Swatch Group Research and Development Ltd, Marin (CH)

(72) Inventors: Paulo BRAVO, Marin-Epagnier (CH); Andres Cabezas Jurin, Yverdon-les-Bains (CH)

(73) Assignee: The Swatch Group Research and Development Ltd, Marin (CH)

(21) Appl. No.: 18/430,012

(22) Filed: Feb. 1, 2024

(30) Foreign Application Priority Data
Mar. 6, 2023 (EP) 23160133.7

(51) Int. Cl. G04B 17/32; G04B 18/06

(52) U.S. Cl. CPC G04B 17/325; G04B 18/06

(57) ABSTRACT

A device (6) for autonomously adjusting the active length of a balance spring (5), for an oscillator (4, 5) of the sprung balance type, including a cock (12) mounted on a plate (13) of a horological movement (2) and in which cock a balance staff pivots, the balance spring (5) including an inner end integral with the balance staff and an outer end integral with a stud (8) fastened to a stud-holder (10), the stud-holder (10) being pivotally mounted on the cock (12) concentrically with the balance staff, and means for modifying the active length of the balance spring (5).

### CROSS REFERENCE TO RELATED APPLICATIONS

This application claims priority to European Patent Application No. 23160133.7 filed Mar. 6, 2023, the entire contents of which are incorporated herein by reference.

### TECHNICAL FIELD OF THE INVENTION

The invention relates to a device for autonomously adjusting the active length of a balance spring, for an oscillator of the sprung balance type.

The invention further relates to a horological movement including the device for autonomously adjusting the active length of a balance spring and an oscillator of the sprung balance type.

The invention further relates to a timepiece, in particular a watch, including the horological movement.

### TECHNOLOGICAL BACKGROUND

In watches fitted with mechanical oscillators of the sprung balance type, mechanisms for manually adjusting the active length of the balance spring are known.

For example, in regular manual adjustment mechanisms, the outer end of the balance spring is immobilised by a stud fastened to a stud-holder integral with a cock. An index that can rotate relative to the stud-holder is provided to adjust the active length of the balance spring, thereby allowing the frequency of the sprung balance to be adjusted. The index is a pivoting lever, typically provided with two arms, centred on the coordinate of the balance staff. A first arm of the index carries, for example, two pins between which the balance spring is free. A second arm of the index can be manually operated to rotate the index through a certain angle about the balance staff. This allows the actual position of the counting point to be changed. As the index rotates, the active length of the balance spring reduces or increases. However, one drawback of such a manual adjustment device is that the earth's gravity influences the oscillation frequency of the sprung balance depending on the orientation of the corresponding horological movement. As a result, the rate of a watch can vary significantly, in particular between its horizontal and vertical positions. Moreover, when the balance spring moves between the pins due to the play therebetween, the oscillations of the sprung balance alter its active length and thus cause a slight variation in the oscillation frequency of the sprung balance assembly.

In order to limit the negative effects of gravity, one solution known in particular from patent CH 705 605 B1, implements a device for adjusting the active length of the balance spring, wherein the index carries clamping means designed to clamp an end portion of the balance spring in order to define the active length thereof. The outer end of the balance spring is also integral with a fastening system movably mounted relative to the index and arranged to cooperate therewith. The clamping means, consisting for example of a pin/eccentric clamping system wherein the end portion of the balance spring is clamped, can be loosened or tightened at will by a watchmaker. Once the watchmaker has loosened the pin/eccentric clamping system, the fastening system can be moved using a tool, thus allowing the balance spring to be moved relative to the index, which remains stationary, and thus relative to the pin, thus allowing the active length of the balance spring to be modified. The watchmaker can then clamp the balance spring against the pin by tightening the clamping system, to return the adjustment device to its operating position. However, such a solution remains a manual adjustment solution, which has the drawback of considerably limiting the precision of the adjustment used to offset the effects of gravity. Moreover, such a solution is tedious to implement, due to the various manual adjustment steps to be carried out by a watchmaker to make the adjustment.

### SUMMARY OF THE INVENTION

The purpose of the invention is thus to provide a device for adjusting the active length of a balance spring, for an oscillator of the sprung balance type, making it possible to offset the effects of gravity, in particular disturbances to the isochronism of the balance of the oscillator, in a simple, precise and autonomous manner, and compensating for the above-mentioned drawbacks of the prior art.

To this end, the invention relates to a device for autonomously adjusting the active length of a balance spring, for an oscillator of the sprung balance type, comprising a cock mounted on a plate of a horological movement and in which cock a balance staff pivots, the balance spring having an inner end integral with the balance staff and an outer end integral with a stud fastened to a stud-holder, the stud-holder being pivotably mounted on the cock concentrically with the balance staff, and means for modifying the active length of the balance spring.

According to the invention, the means for modifying the active length of the balance spring comprise:
a first arm able to move between a rest position and a correction position of the device, the first arm having a first free end and a second end cooperating with a first pair of pins mounted on the stud-holder, the first pair of pins being angularly offset relative to the stud;
a second arm able to move between a rest position and a correction position of the device, the second arm having a first free end and a second end cooperating with a second pair of pins mounted on the stud-holder, the second pair of pins being angularly offset relative to the first pair of pins and to the stud;
resilient stressing means configured to exert a resilient restoring action on the arms to return them to the rest position;
a spherical inertia block, rotatable about two mutually perpendicular axes, the inertia block being arranged to move as a function of gravity, the movement of the inertia block rotating a shaft on which a cam is mounted, the rotation of the cam causing the arm to move, and translating a lever arranged to cooperate with the second arm, act on the balance spring and simultaneously modify the active length of the balance spring.

In accordance with other advantageous alternative embodiments of the invention:
the spherical inertia block comprises a solid part and a recessed part, the solid part forming an unbalance allowing the sphere to return to its rest position;
the spherical inertia block comprises a first ring on a large circle of the spherical inertia block, and a second ring encircling the spherical inertia block, each ring defining a degree of rotation of the spherical inertia block;
the first ring and the spherical inertia block form an element made in one piece;
the first ring comprises at least one recess arranged to cooperate with a feeler integral with the lever, the lever moving as the feeler passes through the recess, the at least one recess corresponding to a correction position;
the cam is a radial cam with an external profile;
when the device is in the rest position, a flat portion of the cam is in contact with the first arm, and when the device is in the correction position, a corner or angle of the cam is in contact with the first arm;
the cam is in permanent contact with the free end of the first arm whatever the position of the inertia block;
the free end of the first arm comprises resiliently deformable adjustment means, the adjustment means being in the form of a strip-spring, a first end of which is integral with the arm and another end of which is free, the free end being arranged to be stressed and to adjust the length of the first arm;
the free end of the second arm comprises resiliently deformable adjustment means, the adjustment means being in the form of a strip-spring, a first end of which is integral with the arm and another end of which is free, the free end being arranged to be stressed and to adjust the length of the second arm;
the device comprises means for adjusting the resilient stress, the adjustment means being in the form of a screw, the screw passing through the free end and bearing against the arm;
the first pair of pins is fastened to the stud holder via a first support, the first arm being arranged so that it slides between the two pins and comes into contact with the outer coil of the balance spring when in the correction position;
the second pair of pins is fastened to the stud holder via a second support, the second arm being arranged so that it passes between the two pins and comes into contact with the outer coil of the balance spring when in the correction position.

One advantage of the adjusting device according to the invention lies in the fact that it comprises an inertia block mounted so as to rotate freely and cooperating indirectly with a movable arm arranged to act on the outer coil of the balance spring. Rotation of the inertia block, which is freely subject to gravity, thus causes the arm to move between a rest position and a correction position of the device, and simultaneously acts on the balance spring to modify the active length of the balance spring, allowing the latter to be adjusted in order to compensate for disturbances to the isochronism of the balance due to gravity. As a result, the adjustment device according to the invention allows the oscillator's rate to be precisely compensated for as a function of its position in space, by offsetting the disturbances to the isochronism of the balance due to gravity, in an autonomous manner.

The invention further relates to a horological movement including the adjustment device described above, and which includes the features mentioned in dependent claim 14.

The invention further relates to a timepiece including the horological movement described above, and which includes the features mentioned in dependent claim 15.

Further features and advantages of the present invention will become apparent from the following description of a preferred embodiment, given by way of a non-limiting example with reference to the accompanying drawings.

### BRIEF DESCRIPTION OF THE FIGURES

The purposes, advantages and features of the device for adjusting the active length of a balance spring, and of the horological movement and timepiece comprising it, will become clearer in the following description which is given on the basis of at least one non-limiting embodiment illustrated by the drawings in which:

FIG. 1 is a perspective view of a horological movement of a watch comprising a device for adjusting the active length of a balance spring according to the invention;

FIG. 2 is an exploded perspective view of the adjustment device shown in FIG. 1;

FIG. 3 is a top view of the adjustment device shown in FIG. 1.

### DETAILED DESCRIPTION OF THE INVENTION

In the following description, reference is made to a horological movement equipped with a device for adjusting the active length of a balance spring, for an oscillator of the sprung balance type. The usual components of the horological movement, which are well known to a person skilled in the art, are described only in simplified form or not at all. A person skilled in the art will be able to adapt these various components and make them cooperate for the operation of the horological movement. In particular, everything relating to the escapement mechanism of the horological movement will not be described below, although such an escapement mechanism can advantageously cooperate with the adjustment device according to the invention.

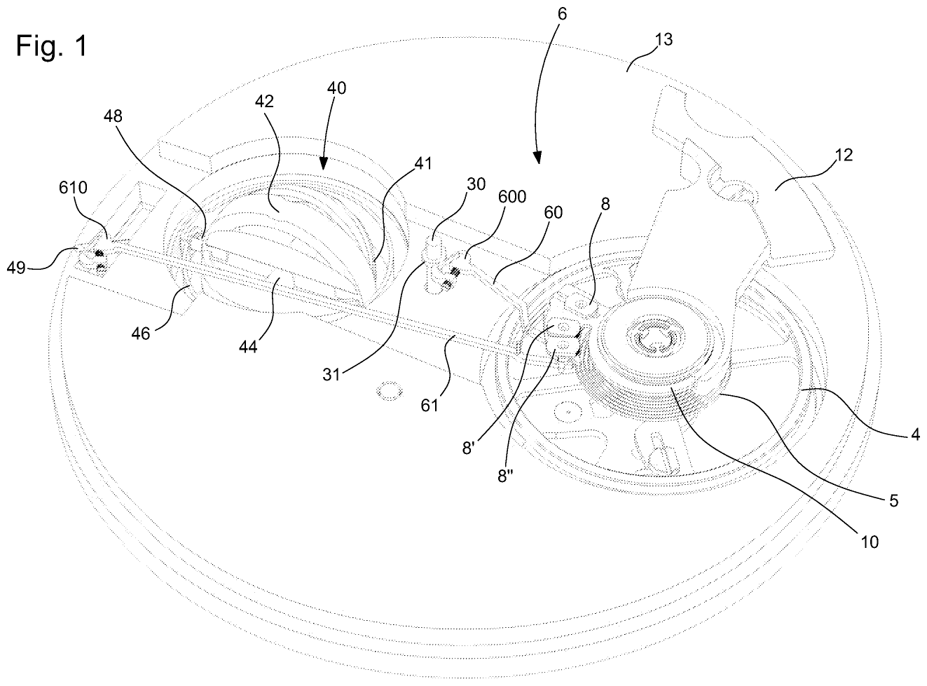

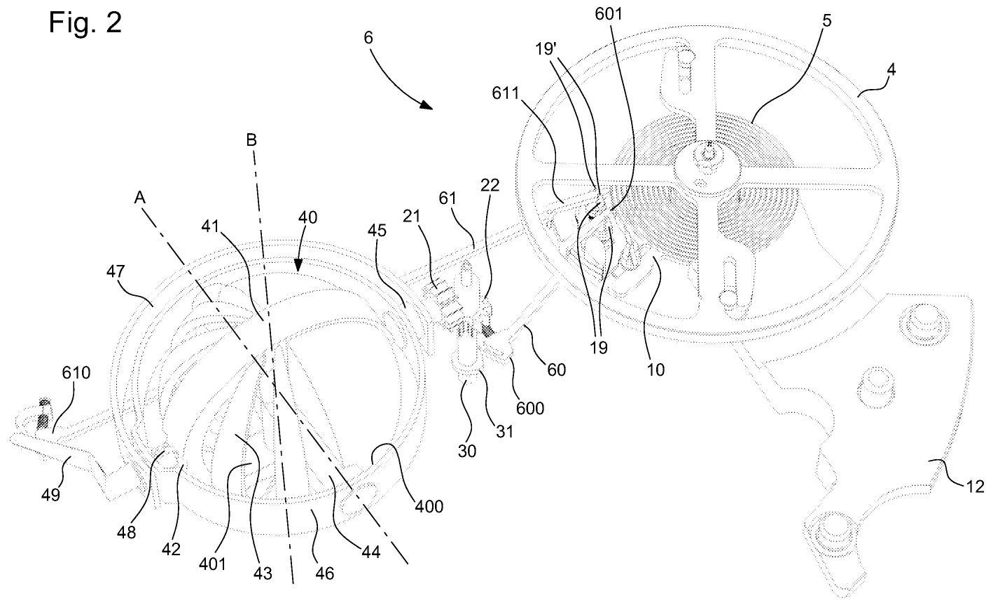

FIG. 1 shows part of a timepiece 1, which includes a horological movement 2. In the particular example embodiment shown in FIG. 1, the timepiece 1 is a watch. The horological movement 2 includes an oscillator equipped with a balance 4 and a balance spring 5, and a device 6 for autonomously adjusting the active length of the balance spring 5. Conventionally, the balance spring 5 is fastened to a balance staff by its inner end (not visible). The balance staff has one end pivotally mounted in a balance bridge (the latter is not visible in the figures for the sake of clarity). The outer end of the balance spring 5 is fastened in the conventional way to a stud 8 fastened to a stud-holder 10, the stud-holder 10 being made integral with a cock 12 by light clamping. More specifically, the stud-holder 10 is pivotally mounted on the cock 12 concentrically with the balance staff 4, as shown in FIG. 2. The balancer staff is pivotally mounted in the cock 12.

The means 6 for modifying the active length of the balance spring 5 are capable of modifying the active length of the balance spring 5 by acting on the length of the outer coil of the balance spring 5. In a particular example embodiment illustrated in FIG. 1, the means for modifying the active length of the balance spring 5 include a first arm 60 capable of moving between a rest position and a correction position of the device, the first arm having a first free end 600 and a second end 601 cooperating with a first pair of pins 19 forming a guiding fork for the first arm 60, the first pair of pins 19 being mounted on the stud-holder 10 via a first support 8′ and offset angularly relative to the stud 8. Thus, the second end 601 of the first arm 600 can slides between the first pair of pins 19.

The adjustment device further comprises a second arm 61 capable of moving between a rest position and a correction position of the device, the second arm 61 having a first free end 610 and a second end cooperating with a second pair of pins 19′ forming a guiding fork for the second arm, the second pair of pins 19′ being mounted on the stud-holder 10 via a second support 8″ and offset angularly relative to the first pair of pins 19 and the stud 8. Thus, the second end 610 of the second arm 61 can slides between the second pair of pins 19′.

The means 6 for modifying the active length of the balance spring further comprise a spherical inertia block 40 which is rotatable about two mutually perpendicular axes A, B. The spherical inertia block 40 is arranged to rotate about at least one of the axes A and B as a function of gravity, the movement of the inertia block 40 rotating a shaft 30 on which a cam 31 is mounted and/or moving a lever 49. Thus, rotation of the cam 31 causes the arm 60 to move and act on the balance spring and simultaneously modify the active length of the balance spring 5, and the same applies to the lever 49 which is arranged to cooperate with the second arm 61 and move the latter to act on the balance spring and simultaneously modify the active length of the balance spring 5.

As can be seen in FIG. 2, the inertia block 40 is in the form of a spherical body rotating about the axis A and comprising a solid portion 400 and a perforated portion 401 with perforated elements 43, each portion forming one half of the spherical inertia block 40. Advantageously, the solid portion 400 forms an unbalance and allows the inertia block 40 to return to its rest position.

As can be seen in FIG. 2, the spherical inertia block comprises a first ring 41 on a large circle of the spherical inertia block, and a second ring 46 rotating about the axis B and encircling the spherical inertia block, the inertia block 40 being arranged to rotate in the second ring 46. Thus, each ring rotates about an axis and defines a degree of rotation of the spherical inertia block 40.

The first ring 41 and the spherical inertia block 40 form a one-piece element and the first ring comprises at least one recess 42 arranged to cooperate with a feeler 48 integral with the lever 49, the lever moving as the feeler 49 passes through the recess 48. The recess 42 corresponds to a correction position, and it goes without saying that there can be several recesses on the surface of the first ring 41 so as to define a plurality of correction positions.

The sphere 40 and the second ring 46 are fastened to the plate 13 via a semi-circular frame 47, each end of the frame 47 having an opening to allow the passage of the lever 49 acting on the second arm 61 and of a drive shaft 45 driving a first pinion 21 meshing with a second pinion 22 integral with the shaft 30 on which the cam 31 acting on the first arm 60 is mounted.

The adjustment device comprises resilient stressing means configured to exert a resilient restoring action on the arms 60, 61 to return them to the rest position. The resilient stressing means are in the form of a rod 62 integral with the arm 60 and a strip-spring 63 integral with the stud-holder 10, the strip-spring 61 exerting a restoring force on the rod 62 and exerting a resilient restoring action on the arm 60. Resilient stressing means are further associated with the second arm 61, and comprise a rod 64 integral with the second arm 61 and a strip-spring 65 integral with the stud-holder 10, the strip-spring 65 exerting a restoring force on the rod 64 and exerting a resilient restoring action on the second arm 61.

The adjustment device 6 further comprises means for adjusting the arms 60, 61, the free end 600, 610 of the first and second arms 60, 61 comprising resiliently deformable adjustment means for lengthening or shortening the length of the arms. The adjustment means are in the form of a strip-spring, a first end of which is integral with the arm and another end of which is free, the free end being arranged to be stressed and to adjust the length of the arms 60, 61, the strip-spring forming a space between itself and the free end of each arm. This adjustment is necessary depending on the position of the balance spring and the correction to be made thereto.

The means for modifying the active length of the balance spring 5 include two pins 19 fastened to the second stud 8′, the second end 601 of the arm 60 being arranged so that it slides between the two pins 19 and comes into contact with the outer coil of the balance spring 5 in the correction position and thus modifies the active length of the balance spring.

The means for modifying the active length of the balance spring 5 comprise two further pins 19′ fastened to the third stud 8″, the second end 611 of the second arm 61 being arranged so that it passes between the two pins 19′ and comes into contact with the outer coil of the balance spring 5 in the correction position.

Moreover, each arm 60, 61 comprises means for adjusting the resilient stress, the adjustment means being in the form of a screw, the screw passing through the free end of the strip-spring and bearing against the arm. Thus, when the screw is screwed in, the free end of the strip-spring moves further away and the distance between the strip-spring and the free end 600, 610 of the arms 60, 61 increases, which allows the length of the arms 60, 61 to be increased. Conversely, when the screw is unscrewed, the free end of the strip-spring moves closer and the distance between the strip-spring and the free end 600, 610 of the arms 60, 61 decreases, which allows the length of the arms 60, 61 to be increased.

According to a preferred embodiment, the inertia block 40 is free to rotate about the two axes A and B. Thus, movement of the inertia block 40 causes the first ring 41 and/or the second ring 46 to rotate, and respectively rotates the drive shaft 45 which drives the first pinion 21 meshing with the second pinion 22 integral with the shaft 30 on which the cam 31 is mounted, and/or translates the lever 49.

Thus, a movement of the inertia block 40 leads to a movement of at least one of the arms 60, 61 to act simultaneously on the means for modifying the active length of the balance spring 5. The movement of the arms as a result of the movement of the inertia block 40 subjected to gravity, takes place between a rest position of the device, and a correction position of the device. Each of the arms allows a distinct correction to be made as a function of the position of the watch, and thus allows the active length of the balance spring to be continuously adjusted in order to compensate for disturbances to the isochronism of the balance due to gravity.

In the preferred example embodiment wherein the device 6 comprises a cam 31 for driving the first arm 60, the cam is integral with the shaft 30 and is in contact with the free end 600 of the first arm 60.

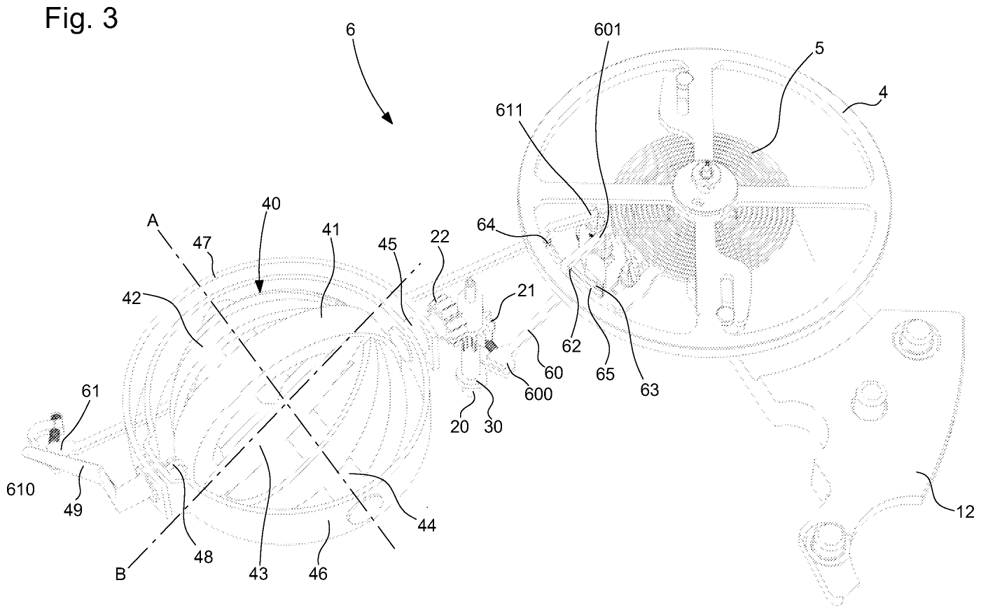

Preferably, cam 31 is a radial cam with an external profile. Although a radial cam with a substantially circular external profile is shown in FIGS. 1 to 3, in practice the shape envisaged for the external profile of the cam will depend on the type of balance spring 5 used and the correction to be made thereto. For example, a radial cam with a triangular, oblong or ovoid external profile can also be used in the context of the present invention. Preferably, and as shown in FIG. 2, when the adjustment device 6 is in the rest position, a flat portion of the cam 31 is in contact with the first arm 60, whereas when the device 6 is in the correction position, a corner or angle of the cam 31 is in contact with the arm 60. Even more preferably, as can be seen in the figures, the cam 31 is in contact with the first arm 60 whatever the position of the inertia block 40.

It is thus conceivable that, depending on the position of the horological movement 2 in space, the spherical inertia block 40, which is freely subject to gravity, can pivot and cause the arms 60, 61 to move. In so doing, the movement of the inertia block makes it possible to act simultaneously on the means for modifying the active length of the balance spring 5, making it possible to continuously adjust the active length of the balance spring in order to compensate for disturbances to the isochronism of the balance due to gravity.

Once the inertia block has stabilised following its change of position, the device will return to its rest position by itself thanks to the action of the unbalance formed by the solid portion 400 of the inertia block 40.

The invention further relates to a horological movement 2 including an oscillator 4, 5 of the sprung balance type and a device 6 for autonomously adjusting the active length of the balance spring 5 as described above.

The invention further relates to a timepiece 1 including a horological movement 2 equipped with a device 6 for autonomously adjusting the active length of the balance spring 5 as described above.

1. A device (6) for autonomously adjusting the active length of a balance spring (5), for an oscillator (4, 5) of the sprung balance type, comprising a cock (12) mounted on a plate (13) of a horological movement (2) and in which cock a balance staff pivots, the balance spring (5) including an inner end integral with the balance staff and an outer end integral with a stud (8) fastened to a stud-holder (10), the stud-holder (10) being pivotally mounted on the cock (12) concentrically with the balance staff, and means for modifying the active length of the balance spring (5);
wherein the means for modifying the active length of the balance spring comprise:
a first arm (60) able to move between a rest position and a correction position of the device, the first arm (60) having a first free end (600) and a second end (601) cooperating with a first pair of pins (19) mounted on the stud-holder (10), the first pair of pins (19) being angularly offset relative to the stud (8);
a second arm (61) capable of moving between a rest position and a correction position of the device, the second arm having a first free end (610) and a second end (611) cooperating with a second pair of pins (19′) mounted on the stud-holder (10), the second pair of pins (19′) being angularly offset relative to the first pair of pins (19) and to the stud (8);
resilient stressing means (62, 63, 64, 65) configured to exert a resilient restoring action on the arms (60, 61); and
a spherical inertia block (40), rotatable about two mutually perpendicular axes, the inertia block being arranged to move as a function of gravity, the movement of the inertia block (40) rotating a shaft (30) on which a cam (31) is mounted, the rotation of the cam (31) causing the arm (60) to move, and translating a lever (49) arranged to cooperate with the second arm (61), and act on the balance spring and simultaneously modify the active length of the balance spring (5).

2. The device (6) for autonomously adjusting the active length of a balance spring (5) according to claim 1, wherein the spherical inertia block (40) comprises a solid part (400) and a recessed part (401), the solid part (400) forming an unbalance allowing the sphere to return to its rest position.

3. The device (6) for autonomously adjusting the active length of a balance spring (5) according to claim 2, wherein the spherical inertia block comprises a first ring (41) on a large circle of the spherical inertia block, and a second ring (46) encircling the spherical inertia block, each ring defining a degree of rotation of the spherical inertia block (40).

4. The device (6) for autonomously adjusting the active length of a balance spring (5) according to claim 3, wherein the first ring (41) and the spherical inertia block (40) form a one-piece element.

5. The device (6) for autonomously adjusting the active length of a balance spring (5) according to claim 3, wherein the first ring comprises at least one recess (42) arranged to cooperate with a feeler (48) integral with the lever (49), the lever moving when the feeler (49) passes through the recess (48), the at least one recess (42) corresponding to a correction position.

6. The device (6) for autonomously adjusting the active length of a balance spring (5) according to claim 1, wherein the cam (31) is a radial cam with an external profile.

7. The device (6) for autonomously adjusting the active length of a balance spring (5) according to claim 1, wherein, when the device (6) is in the rest position, a flat portion of the cam (31) is in contact with the first arm (60), and when the device (6) is in the correction position, a corner or angle of the cam (31) is in contact with the first arm (60).

8. The device (6) for autonomously adjusting the active length of a balance spring (5) according to claim 1, wherein the cam (31) is in permanent contact with the free end (60) of the first arm (60) whatever the position of the inertia block (40).

9. The device (6) for autonomously adjusting the active length of a balance spring (5) according to claim 1, wherein the free end (600) of the first arm (60) comprises resiliently deformable adjustment means, the adjustment means being in the form of a strip-spring, a first end of which is integral with the arm and another end of which is free, the free end being arranged to be stressed and to adjust the length of the first arm (60).

10. The device (6) for autonomously adjusting the active length of a balance spring (5) according to claim 1, wherein the free end (610) of the second arm (61) comprises resiliently deformable adjustment means, the adjustment means being in the form of a strip-spring, a first end of which is integral with the arm and another end of which is free, the free end being arranged to be stressed and to adjust the length of the second arm (61).

11. The device (6) for autonomously adjusting the active length of a balance spring (5) according to claim 9, further comprising means for adjusting the resilient stress, the adjustment means being in the form of a screw, the screw passing through the free end and bearing against the arm.

12. The device (6) for autonomously adjusting the active length of a balance spring (5) according to claim 1, wherein the first pair of pins (19) is fastened to the stud-holder (10) via a first support (8′), the arm (60) being arranged so that it slides between the two pins (19) and comes into contact with the outer coil of the balance spring in the correction position.

13. The device (6) for autonomously adjusting the active length of a balance spring (5) according to claim 1, wherein the second pair of pins (19′) is fastened to the stud-holder (10) via a second support (8″), the arm (61) being arranged so that it passes between the two pins (19) and comes into contact with the outer coil of the balance spring in the correction position.

14. A horological movement (2) including an oscillator (4, 5) of the sprung balance type and the device (6) for autonomously adjusting the active length of the balance spring (5) in accordance with claim 1.

15. A timepiece (1) including the horological movement (2) in accordance with claim 14.
